(19) United States
(12) Patent Application Publication
(10) Pub. No.: US 2014/0175236 A1
(43) Pub. Date: Jun. 26, 2014

(54) FRAME ASSEMBLY STRUCTURE

(71) Applicant: Minh Trong Thi NGUYEN, Thi Xa Thuan An, Tinh Binh Duong (VN)

(72) Inventor: Minh Trong Thi NGUYEN, Thi Xa Thuan An, Tinh Binh Duong (VN)

(21) Appl. No.: 13/722,875

(22) Filed: Dec. 20, 2012

(51) Int. Cl. F16M 11/00

(52) U.S. Cl. CPC F16M 11/00
USPC 248/163.1; 248/127

(57) ABSTRACT

A frame assembly structure includes two lateral panels, a corner post, and a positioning element. The positioning element has an elongate body portion. A. shoulder portion extends from each of two ends of the body portion. An included angle is formed between the shoulder portion and the body portion. The shoulder portion has two hanger holes each having a round hole expanding to form a recess. The body portion has two through holes centrally. Hanger nails are disposed at each lateral panel, and correspond in position to the hanger holes. Heads of the hanger nails penetrate the round holes such that the recesses receive bodies of the hanger nails engageably, allowing two adjacent lateral panels to be connected at right angle. The corner post is engaged with the two adjacent lateral panels and engaged with the positioning element by passing fastening elements through the through holes.

### BACKGROUND OF THE INVENTION

1. Technical Field

The present invention relates to furniture, and more particularly, to a frame assembly structure of a piece of furniture.

2. Description of Related Art

To cut costs, it is not uncommon for furniture to be made in those manufacturing countries which feature low material costs and cheap labor and then exported to end-user countries. Nonetheless, bulky pieces of furniture tell a different story: their parts are made in the manufacturing countries, and then the finished parts are shipped to the end-user countries for assembly, because their parts are made mostly from bulky pieces of raw materials which inevitably incur high shipping costs when shipped internationally. However, the prior art has a drawback, that is, the end-user countries usually have high labor costs. Accordingly, it is imperative to provide a way of putting the parts together simply and quickly.

U.S. Pat. No. 6,752,364 discloses a collapsible frame for a piece of furniture, which is characterized in that four elongate panels are fixed in place by means of a hinge-like metallic component to form a frame. The frame is collapsible to thereby reduce the volume thereof during delivery. The frame is assembled by opening the otherwise collapsed frame and then putting its parts together; hence, the frame features ease of use. However, the collapsible frame of U.S. Pat. No. 6,752,364 has the following drawbacks: the frame thus collapsed is still bulky; when collapsed, a quadrangle formed by four elongate panels ends up with an overly large length and an overly large space, thereby resulting in a waste of package volume; if the panels are paired and put together before being delivered to an end-user country for fastening, not only will the resultant assembly process be prolonged, but the collapsible frame will no longer be positioned and assembled quickly.

### BRIEF SUMMARY OF THE INVENTION

It is an objective of the present invention to provide a frame assembly structure comprising independently deliverable elements to thereby minimize their volume in the course of delivery and ensure convenient and quick assembly thereof.

In order to achieve the above and other objectives, the present invention provides a frame assembly structure comprising two lateral panels, a corner post, and a positioning element. The positioning element has an elongate body portion with two ends each extending to form a shoulder portion at a predetermined included angle with respect to the body portion. The shoulder portion has at least a hanger hole. The body portion has at least a through hole centrally. The hanger hole has a round hole. A recess extends from the periphery of the round hole and dents along a shorter axis of the positioning element. Hanger nails are disposed at each of the two lateral panels, correspond in position to the two hanger holes of a corresponding one of the two shoulder portions of the positioning element, and correspond in quantity to two said hanger holes. Heads of the hanger nails penetrate the round holes of the hanger holes of the positioning element, respectively, in a manner that the recesses receive bodies of the hanger nails to form engagement structures, respectively. Heads of the hanger nails penetrate the round holes of the hanger holes of the positioning element, respectively, in a manner that the recesses receive bodies of the hanger nails to form engagement structures, respectively. Due to the two shoulder portions of the positioning element, two adjacent lateral panels form a predetermined included angle. The corner post is engaged with the two adjacent lateral panels and engaged with the positioning element by passing a fastening element through the at least a through hole centrally disposed at the positioning element.

Accordingly, the frame assembly structure of the present invention has the following advantages: its components can be independently arranged and packed to attain the least package volume, save shipping costs, enable quick easy assembly, and save assembly costs.

### BRIEF DESCRIPTION OF THE SEVERAL VIEWS OF THE DRAWINGS

FIG. 1 is a perspective view of an assembled frame assembly structure according to an embodiment of the present invention;

FIG. 2 is an exploded view of the encircled portion of FIG. 1;

FIG. 3 is a perspective view of a positioning element and a lateral panel of FIG. 2 when assembled;

FIG. 4 is a front view of the positioning element; and

FIG. 5 is a top view of the positioning element.

### DETAILED DESCRIPTION OF THE INVENTION

The present invention is hereunder illustrated with an embodiment in conjunction with the accompanying drawings.

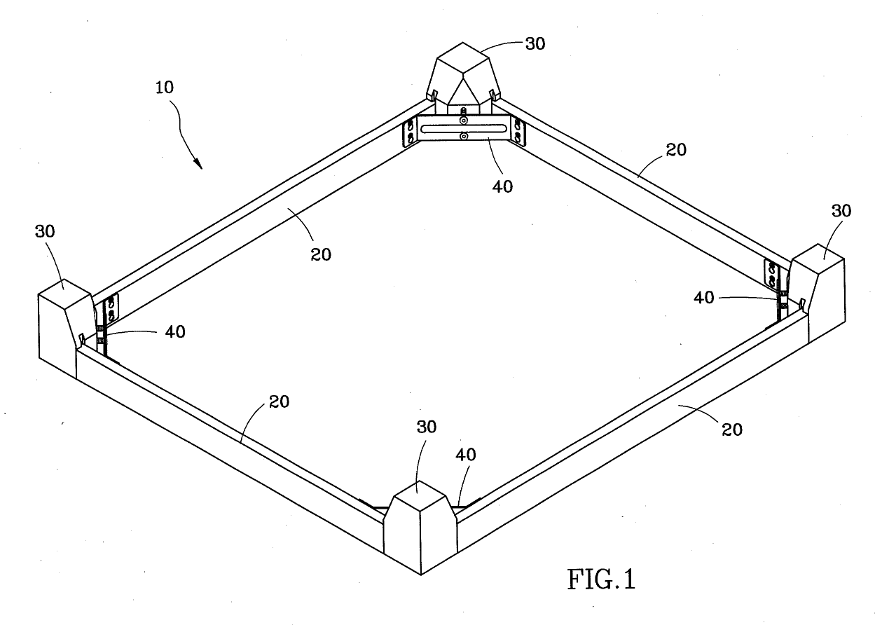

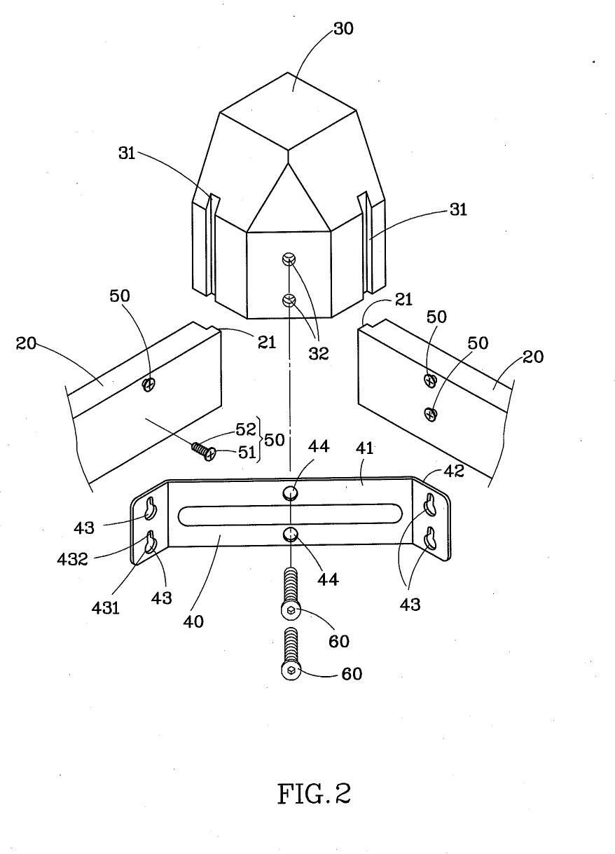

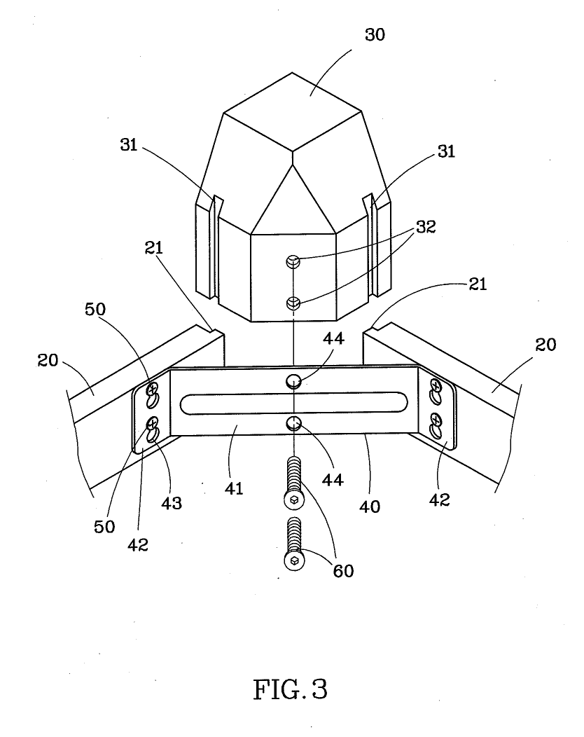

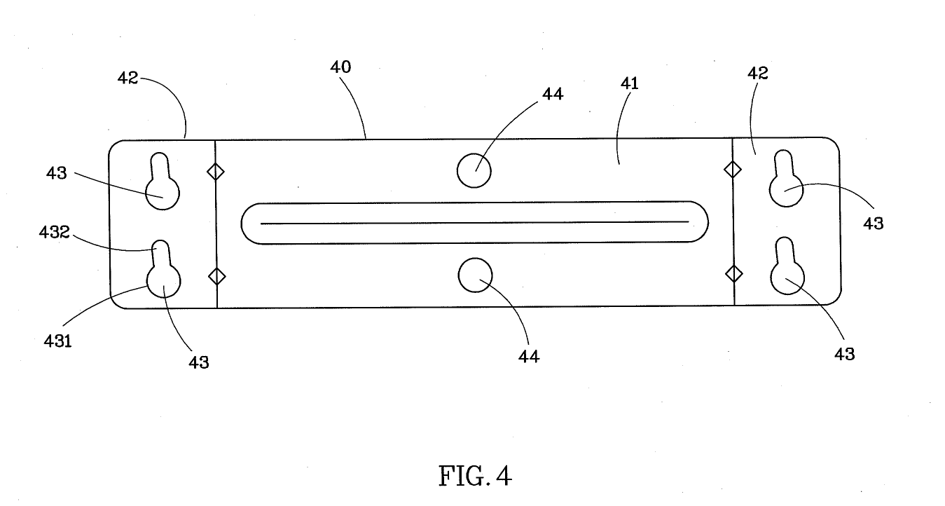

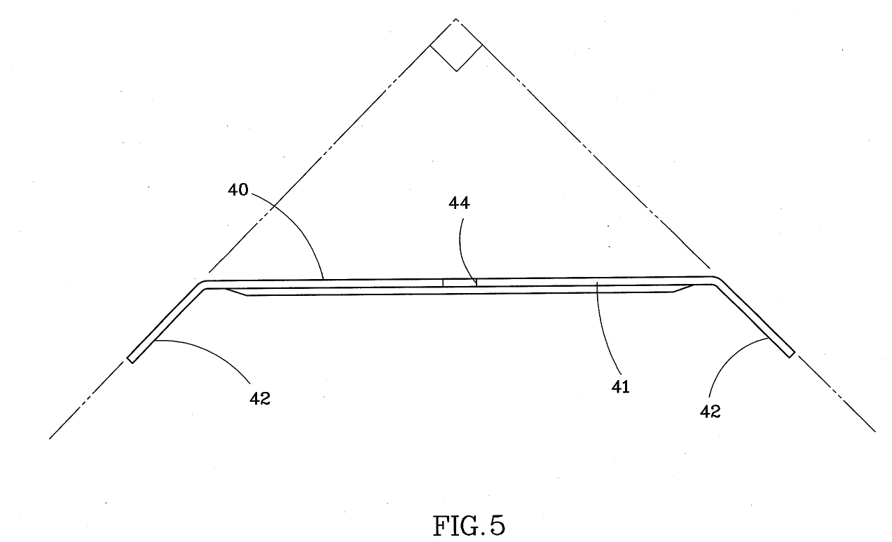

Referring to FIG. 1, there is shown a perspective view of a frame assembly structure 10 of a sofa according to an embodiment of the present invention. The frame assembly structure 10 comprises four lateral panels 20, four corner posts 30, and four positioning elements 40. For the sake of illustration, the description of FIG. 1 is restricted to the encircled portion thereof. Referring to FIG. 2, there is shown an exploded view of the encircled portion of FIG. 1. The positioning element 40, as shown in FIGS. 4, 5, has an elongate body portion 41. A shoulder portion 42 extends from each of the two ends of the body portion 41. In this embodiment, a predetermined included angle of 45 degrees is formed between the shoulder portion 42 and the body portion 41, wherein the shoulder portion 42 has two hanger holes 43, and the body portion 41 has two through holes 44 centrally. The hanger holes 43 each have a round hole 431. A recess 432 extends from the periphery of the round hole 431 and dents along the shorter axis of the positioning element 40. Hanger nails 50 are disposed at each of two said lateral panels 20, correspond in position to two said hanger holes 43 of a corresponding one of the two shoulder portions 42 of the positioning element 40, and correspond in quantity to two said hanger holes 43. Referring to FIG. 3, an assembly process of the frame assembly structure 10 entails passing heads 51 of the hanger nails 50 through the round holes 431 of the hanger holes 43 of the positioning element 40, respectively, in a manner that the recesses 432 receive bodies 52 of the hanger nails 50 to form engagement structures (not shown), respectively. In this embodiment, due to the two shoulder portions 42 of the positioning element 40, two said lateral panels 20 together form therebetween a predetermined included angle of 90 degrees. The corner post 30 is jointed to two said lateral panels 20 by a mortise-and-tenon joint mechanism (further described below), respectively. Then, the corner post 30 is fastened to the positioning element 40, by passing two fastening elements 60 through the two through holes 44 disposed centrally at the positioning element 40, respectively. In this embodiment, the aforesaid mortise-and-tenon joint mechanism is implemented, by engaging two grooves 31 of the corner post 30 with two ribs 21 disposed at the two adjacent ends of two said lateral panels 20, respectively. The corner post 30 has two screw holes 32 corresponding in position to two said through holes 44 of the positioning element 40, respectively, such that two said fastening elements 60 can be screwed to the two screw holes 32, respectively. After the fastening elements 60 have been screwed to the screw holes 32, respectively, the hanger nails 50 can be tightened further. At this point in time, it is feasible to apply a resin adhesive between the corner post 30 and the lateral panels 20 to adhere them to each other further.

Advantages of the present invention are as follows: in the course of their shipping, components are independent of each other and are not put together, wherein the hanger nails 50 are fastened to the lateral panels 20 to enable tight alignment and package and thereby minimize package volume; an assembly process entails coupling together the lateral panels 20 by the positioning elements 40, then coupling the corner posts 30 to the lateral panels 20, respectively, and eventually fastening the fastening elements 60, such as bolts, to the positioning elements 40, respectively; hence, the assembly process is convenient and thus can be quickly carried out even by an unskilled worker.

Although a quadrilateral frame is disclosed in the aforesaid embodiment of the present invention, the frame of the present invention can be of any shape, such as pentagon or hexagon, at the cost of changing the included angle between the body portion 41 and the shoulder portion 42 of the positioning element 40, as long as the spirit embodied in the present invention remains intact. If the frame is a rectangle, a reinforcing transverse bar can be coupled between two opposing lateral panels. Such a simple change does not go beyond the scope of the present invention.

What is claimed is:

1. A frame assembly structure, comprising:
a positioning element having an elongate body portion with two ends each extending to form a shoulder portion at a predetermined included angle with respect to the body portion, the shoulder portion having at least a hanger hole, the body portion having at least a through hole centrally, the hanger hole having a round hole, wherein a recess extends from a periphery of the round hole and dents along a shorter axis of the positioning element;
two lateral panels, wherein hanger nails are disposed at each of two said lateral panels, correspond in position to two said hanger holes of a corresponding one of the two shoulder portions of the positioning element, and correspond in quantity to two said hanger holes, wherein heads of the hanger nails penetrate the round holes of the hanger holes of the positioning element, respectively, in a manner that the recesses receive bodies of the hanger nails to form engagement structures, respectively, in a manner that the recesses receive bodies of the hanger nails to form engagement structures, respectively, wherein two said lateral panels form therebetween a predetermined included angle due to two said shoulder portions of the positioning element; and
a corner post engaged with two said lateral panels and then engaged with the positioning element by passing a fastening element through the at least a through hole centrally disposed at the positioning element.

2. The frame assembly structure of claim 1, wherein the body portion of the positioning element has two said through holes, and the shoulder portions of the positioning element have two hanger holes each.

3. The frame assembly structure of claim 1, wherein the hanger nails and the fastening element are bolts.

4. The frame assembly structure of claim 1, wherein the body portion and each said shoulder portion form therebetween an included angle of 45 degrees substantially, and two said shoulder portions are perpendicular to each other substantially.

5. The frame assembly structure of claim 1, wherein the frame comprises four said lateral panels, four said corner posts, and four said positioning elements.

6. A frame assembly structure comprising a positioning element having an elongate body portion with two ends each extending to form a shoulder portion at a predetermined included angle with respect to the body portion, the shoulder portion having at least a hanger hole, the body portion having at least a through hole centrally.

7. The frame assembly structure of claim 6, wherein the body portion and each said shoulder portion form therebetween an included angle of 45 degrees substantially, and two said shoulder portions are perpendicular to each other substantially.

8. The frame assembly structure of claim 6, wherein the hanger hole has a round hole, and a recess extends from a periphery of the round hole and dents along a shorter axis of the positioning element.

9. The frame assembly structure of claim 6, wherein the body portion of the positioning element has two said through holes, and the shoulder portions of the positioning element have two hanger holes each.
